(19) United States
(12) Patent Application Publication
(10) Pub. No.: US 2005/0042510 A1
(43) Pub. Date: Feb. 24, 2005

(54) Alkaline dry battery

(76) Inventors: Kenji Yamamoto, Osaka (JP); Takashi Mushiga, Osaka (JP); Seiji Wada, Osaka (JP); Shinichi Sumiyama, Osaka (JP)

Correspondence Address: MCDERMOTT WILL & EMERY LLP, 600 13TH STREET, N.W., WASHINGTON, DC, 20005-3096, US

(21) Appl. No.: 10/909,846

(22) Filed: Aug. 3, 2004

(30) Foreign Application Priority Data
Aug. 6, 2003 (JP) JP2003-287725

(51) Int. Cl. H01M 2/08

(52) U.S. Cl. 429/185; 429/184

(57) ABSTRACT

An alkaline dry battery of the present invention includes a battery case, a sealing plate for sealing an opening of the battery case and a gasket arranged between the battery case and the sealing plate, and further includes, between the gasket and the battery case, a sealant layer comprising 10 to 60 wt % of higher saturated fatty acid having a carbon number of 12 to 22 and 90 to 40 wt % of univalent unsaturated fatty acid. The sealant layer is obtained by using a sealant capable of being applied without the help of an organic solvent, and therefore does not cause harmful effect to the environment and has excellent sealing property.

### BACKGROUND OF THE INVENTION

Due to growing environmental awareness in recent years, environmentally friendliness is required of technological innovation. In particular, it is required to take environmental measures such as reduction of VOC (volatile organic compounds). For that purpose, attempts have been made to achieve a solventless system or an aqueous system.

As a sealant for alkaline dry batteries, there have been used a liquid gasket, a mixture of blown asphalt and polybutene, or the like.

Further, in the field of non-aqueous electrolyte batteries, it has been proposed to mix nondrying mineral oil or nondrying vegetable oil with the blown asphalt sealant to give flexibility and high adhesion property to the blown asphalt sealant (e.g., see Examined Patent Publication No. SHO61-36344).

As a solvent for such these sealants, an organic solvent having high solubility (SP value) and odor is used, for example, toluene and xylene. In general, a sealant layer is formed by applying the sealant using the organic solvent to a desired region and volatizing the organic solvent therefrom.

That is, the conventionally used sealant cannot be dissolved in anything but an organic solvent. Therefore, if the organic solvent is not used, the sealant needs to melt by heating, increasing energy consumption.

To solve the above problem, the present invention utilizes a sealant capable of being applied without the help of an organic solvent to provide an alkaline dry battery which is well-sealed and does not cause harmful effect to the environment.

### BRIEF SUMMARY OF THE INVENTION

An alkaline dry battery according to the present invention includes a battery case, a sealing plate for sealing an opening of the battery case and a gasket arranged between the battery case and the sealing plate, and further includes, between the gasket and the sealing plate, a sealant layer comprising 10 to 60 wt % of higher saturated fatty acid having a carbon number of 12 to 22 and 90 to 40 wt % of univalent unsaturated fatty acid.

It is preferable that the higher saturated fatty acid is stearic acid and the univalent unsaturated fatty acid is oleic acid.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a front view of an alkaline dry battery according to an example of the present invention, partially shown in section.

### DETAILED DESCRIPTION OF THE INVENTION

The present invention relates to an alkaline dry battery including a battery case, a sealing plate for sealing an opening of the battery case and a gasket arranged between the battery case and the sealing plate. The alkaline dry battery further includes, between the gasket and the sealing plate, a layer of a sealant comprising 10 to 60 wt % of higher saturated fatty acid having a carbon number of 12 to 22 and 90 to 40 wt % of univalent unsaturated fatty acid.

When the univalent unsaturated fatty acid in a liquid state is mixed in the above ratio with the higher saturated fatty acid in a solid state having a carbon number of 12 to 22 and exhibiting stability against an electrolyte and an effect of preventing capillary action of an alkaline electrolyte, suitable flexibility and adhesion property are given to the resulting sealant. This eliminates the need of dissolving the sealant in a toxic organic solvent, though which has conventionally been done. Therefore, a sealant layer having excellent sealing property is formed by directly applying the sealant to a desired region. Further, it also eliminates the step of volatizing the organic solvent, permitting cost reduction.

If the carbon number of the higher saturated fatty acid exceeds 22, the higher saturated fatty acid becomes a hard solid. In this case, it becomes difficult to uniformly apply the sealant even if the above-described unsaturated fatty acid is added. On the other hand, when the carbon number is less than 12, the higher saturated fatty acid becomes volatile, turning into hydrolysable lower fatty acid. Therefore, the above-mentioned sealing effect cannot be obtained sufficiently.

The higher saturated fatty acid preferably has a carbon number of 18 to 22. Such higher saturated fatty acid is not easily hydrolyzed, providing stable sealing property.

Examples of the higher saturated fatty acid having a carbon number of 12 to 22 include, lauric acid (carbon number 12), myristic acid (carbon number 14), palmitic acid (carbon number 16), stearic acid (carbon number 18), arachidic acid (carbon number 20) and behenic acid (carbon number 22).

The univalent unsaturated fatty acid has only a single unsaturated bond, and therefore is hard to be oxidized. The univalent unsaturated fatty acid preferably has a carbon number of 18 to 22. Owing to the high carbon number, the univalent unsaturated fatty acid is not easily hydrolyzed. If the carbon number exceeds 22, purification of the unsaturated fatty acid becomes difficult.

Examples of the univalent unsaturated fatty acid include nondrying vegetable oil such as oleic acid and eicosenic acid.

If the content of the higher saturated fatty acid exceeds 60 wt % and the content of the univalent unsaturated fatty acid is less than 40 wt %, the sealant becomes highly viscous to become a semisolid, which brings about difficulty in applying the sealant uniformly. On the other hand, if the content of the higher saturated fatty acid is less than 10 wt % and the content of the univalent unsaturated fatty acid exceeds 90 wt %, the sealant can be applied uniformly. However, the resulting sealant layer easily deteriorates due to oxidation of the unsaturated fatty acid.

Further, it is more preferable that the content of the higher saturated fatty acid is 50 to 60 wt % and the content of the univalent unsaturated fatty acid is 50 to 40 wt %. Since the content of the unsaturated fatty acid is low, the sealant layer is prevented from the deterioration due to the oxidation of the unsaturated fatty acid.

Further, it is preferable to use stearic acid having a carbon number of 18 as the higher saturated fatty acid and oleic acid having a carbon number of 18 as the univalent unsaturated fatty acid because purification of them is easy. In this case, the preferable weight ratio of stearic acid to oleic acid is particularly 60:40 because influence by the oxidation of oleic acid is reduced.

To the above sealant, nondrying mineral oil may be added to give flexibility and adhesion property thereto. Examples of the nondrying mineral oil include, for example, a plasticizer used for rubber and ink, fluorine oil used as a softening agent and process oil such as an industrial lubricant.

If the sealant contains the additional material such as the nondrying mineral oil in addition to the higher saturated fatty acid having a carbon number of 12 to 22 and the univalent unsaturated fatty acid, the total weight thereof corresponds to 100 wt %.

### EXAMPLES 1 TO 6 AND COMPARATIVE EXAMPLES 1 to 2

### (i) Preparation of Sealant

Various higher saturated fatty acids having different carbon numbers as shown in Table 1 were mixed with oleic acid as the univalent unsaturated fatty acid in the weight ratio of 1:1, respectively, to obtain sealants.

TABLE 1

| | Carbon | Higher saturated |
|---|---|---|
| | number | fatty acid |
| Comparative | 10 | Capric acid |
| Example 1 | | |
| Example 1 | 12 | Lauric acid |
| Example 2 | 14 | Myristic acid |
| Example 3 | 16 | Palmitic acid |
| Example 4 | 18 | Stearic acid |
| Example 5 | 20 | Arachidic acid |
| Example 6 | 22 | Behenic acid |
| Comparative | 24 | Lignoceric acid |
| Example 2 | | |

### (ii) Manufacture of Positive Electrode Material Mixture

Manganese dioxide and graphite were mixed in the weight ratio of 90:10. Then, the mixture and an aqueous solution of 40 wt % sodium hydroxide were mixed in the weight ratio of 100:3 and stirred sufficiently, followed by compression molding to form the mixture in the flake form. Then, the resulting flaky positive electrode material mixture was pulverized into granules, which were classified through a sieve. The granules of 10 to 100 mesh were pressure-molded to obtain cylindrical hollow pellets as a positive electrode material mixture. Two of the positive electrode material mixture pellets were placed in a battery case, and were brought into close contact with an inner wall of the battery case using a pressurizing jig.

### (iii) Manufacture of Gel Negative Electrode

Sodium polyacrylate as a gelling agent, an aqueous solution of 40 wt % sodium hydroxide as an alkaline electrolyte and zinc powder as a negative electrode active material were mixed in the weight ratio of 1:33:66 to obtain a gel negative electrode.

### (iv) Assembling of Cylindrical Alkaline Dry Battery

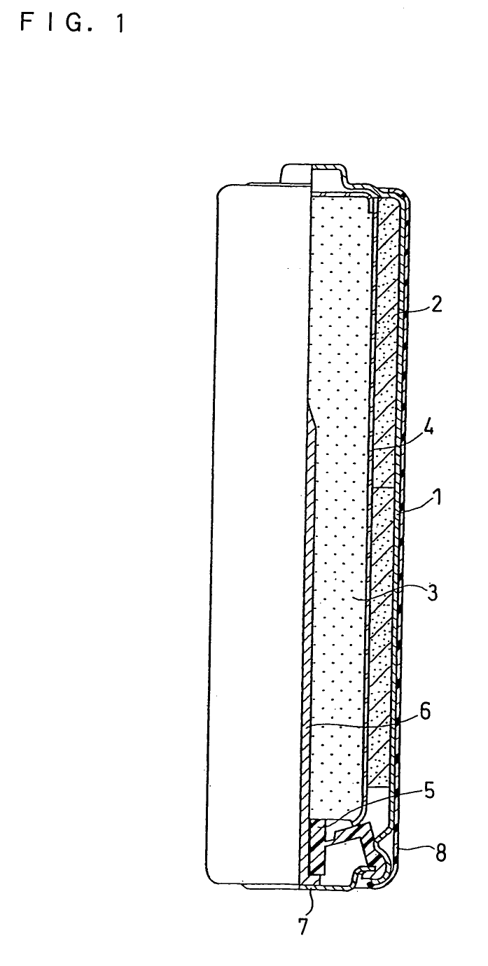

A cylindrical alkaline dry battery configured as shown in FIG. 1 was formed in the following manner.

Inside the positive electrode material mixture 2 in close contact with the inner wall of the battery case 1, a separator 4 in the form of a cylinder with a bottom was arranged. The sealant obtained above was applied to a region where the battery case 1 closely contacts a gasket 5. Inside the separator 4, a predetermined amount of an aqueous solution of 40 wt % sodium hydroxide was injected as an alkaline electrolyte. After a predetermined time, the gel negative electrode 3 obtained above was filled inside the separator 4. The separator 4 used was made of nonwoven fabric mainly comprising polyvinyl alcohol fiber and rayon fiber.

A negative electrode current collector 6 was inserted into the center of the gel negative electrode 3. The negative electrode current collector 6 was integrated with the gasket and a bottom plate (sealing plate) 7 serving also as a negative electrode terminal. Then, an opening end of the battery case 1 was crimped onto the periphery of the bottom plate 7 via the rim of the gasket 5, thereby sealing the opening of the battery case 1. The outer surface of the battery case 1 was coated with an outer jacket 8. Thus, the AA alkaline dry battery (LR6) shown in FIG. 1 was formed.

### COMPARATIVE EXAMPLE 3

A mixture of blown asphalt and polybutene was dissolved in a xylene-based solvent to obtain a sealant. The sealant was applied to a region where a battery case closely contacts a gasket and then the solvent was volatized to form a sealant layer comprising blown asphalt and polybutene between the gasket and the battery case. An alkaline dry battery was formed in the same manner as Example 1 except that the thus obtained sealant layer was used.

The alkaline dry batteries of Examples 1 to 6 and those of Comparative Examples 1 to 3 were subjected to storage tests under the following conditions.

At a temperature of 45° C. and humidity of 90%, the alkaline dry batteries, 100 each, were stored for 1, 3 and 6 months to count the number of batteries that caused leakage of the electrolyte after each storage time.

Further, the alkaline dry batteries, 100 each, were stored at a temperature of 60° C. for 1, 3 and 6 months to count the number of batteries that caused leakage of the electrolyte after each storage time.

TABLE 2
Table 2 shows the results of the storage tests.

| | The number of batteries that caused leakage | | | | | |
|---|---|---|---|---|---|---|
| | Stored at 45° C. | | | Stored at 60° C. | | |
| | 1 | 3 | 6 | 1 | 3 | 6 |
| | month | months | months | month | months | months |
| Comparative | 0 | 0 | 3 | 0 | 0 | 1 |
| Example 1 | | | | | | |
| Example 1 | 0 | 0 | 0 | 0 | 0 | 0 |
| Example 2 | 0 | 0 | 0 | 0 | 0 | 0 |
| Example 3 | 0 | 0 | 0 | 0 | 0 | 0 |
| Example 4 | 0 | 0 | 0 | 0 | 0 | 0 |
| Example 5 | 0 | 0 | 0 | 0 | 0 | 0 |
| Example 6 | 0 | 0 | 0 | 0 | 0 | 0 |
| Comparative | 0 | 0 | 2 | 0 | 0 | 1 |
| Example 2 | | | | | | |
| Comparative | 0 | 0 | 0 | 0 | 0 | 0 |
| Example 3 | | | | | | |

As shown in Table 2, some of the batteries of Comparative Examples 1 and 2 caused the leakage. However, the leakage was not observed in any of the batteries of Examples 1 to 6. This indicates that, when the carbon number of the higher saturated fatty acid is 12 to 22, the battery is sealed well as the conventional battery of Comparative Example 3 is.

### EXAMPLES 7 TO 10 AND COMPARATIVE EXAMPLES 4 TO 5

Stearic acid as the higher saturated fatty acid having a carbon number of 18 and oleic acid as the univalent unsaturated fatty acid were mixed in various weight ratios shown in Table 3 to obtain sealants. Alkaline dry batteries were manufactured in the same manner as Example 1 except that these sealants were used.

TABLE 3

| | Weight ratio of |
|---|---|
| | stearic acid:oleic acid |
| Comparative Example 4 | 0:100 |
| Example 7 | 10:90 |
| Example 8 | 20:80 |
| Example 9 | 40:60 |
| Example 10 | 60:40 |
| Comparative Example 5 | 80:20 |

The alkaline dry batteries of Examples 7 to 10 and those of Comparative Examples 4 and 5 manufactured as described above were subjected to the same storage tests as those performed in Example 1. Table 4 shows the results of the storage tests.

TABLE 4

| | The number of batteries that caused leakage | | | | | |
|---|---|---|---|---|---|---|
| | Stored at 45° C. | | | Stored at 60° C. | | |
| | 1 | 3 | 6 | 1 | 3 | 6 |
| | month | months | months | month | months | months |
| Comparative | 0 | 0 | 4 | 0 | 0 | 1 |
| Example 4 | | | | | | |
| Example 7 | 0 | 0 | 0 | 0 | 0 | 0 |
| Example 8 | 0 | 0 | 0 | 0 | 0 | 0 |
| Example 9 | 0 | 0 | 0 | 0 | 0 | 0 |
| Example 10 | 0 | 0 | 0 | 0 | 0 | 0 |
| Comparative | 0 | 0 | 2 | 0 | 0 | 1 |
| Example 5 | | | | | | |

As shown in Table 4, some of the batteries of Comparative Examples 4 and 5 caused the leakage, but the leakage was not observed in any of the batteries of Examples 7 to 10. This indicates that the battery is sealed well when the mixing ratio of stearic acid and oleic acid in the sealant is 10-60:90-40.

The sealant for the alkaline dry battery according to the present invention brings about the same effect even if it contains bivalent or trivalent unsaturated fatty acid in addition to the higher saturated fatty acid having a carbon number of 12 to 22 and the univalent unsaturated fatty acid.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline dry battery including a battery case, a sealing plate for sealing an opening of said battery case, and a gasket arranged between said battery case and said sealing plate,
characterized in that a sealant layer comprises 10 to 60 wt % of higher saturated fatty acid having a carbon number of 12 to 22, and 90 to 40 wt % of univalent unsaturated fatty acid is arranged between said gasket and said battery case.

2. The alkaline dry battery in accordance with claim 1, wherein said higher saturated fatty acid is stearic acid and said univalent unsaturated fatty acid is oleic acid.
